(19) United States
(12) Patent Application Publication
(10) Pub. No.: US 2012/0209646 A1
(43) Pub. Date: Aug. 16, 2012

(54) Method and computer program product for optimization of maintenance plans

(76) Inventors: Francesco Montrone, Riemerling (DE); Robert Schulte, Longwood, FL (US); Wolfgang Streer, Orlando, FL (US); Ariane Sutor, Grafelfing (DE)

(21) Appl. No.: 13/028,304

(22) Filed: Feb. 16, 2011

(51) Int. Cl. G06Q 10/00

(52) U.S. Cl. 705/7.12

(57) ABSTRACT

A method for optimization of maintenance plans for a plant is provided. The method includes providing input data having at least one of a plurality of indicia regarding a configuration of the plant and a plurality of constraints regarding planned outages of the plant, optimizing the input data, and generating a maintenance plan with maximum equivalent output per a defined observation period regarding the plant.

### FIELD OF THE INVENTION

The present invention relates to the optimization of maintenance plans for industrial plants. More specifically, the present invention relates to a method and a computer program product for providing assistance and optimization regarding planed maintenance operations that are to be performed in industrial plants.

### BACKGROUND OF THE INVENTION

Gasification and integrated gasification combined cycle plants have been shown to contribute to environmentally friendly chemical production as well as to an energy portfolio with reduced CO2 emissions. Despite their important contribution to environmentally friendly industrial practices, little experience is possessed today with their realization and operation.

One important aspect related to the realization and operation of these industrial plants are the high capital expenses incurred with the construction of the plants. In order for the plants to be economically viable, their initial expenses should be offset by sufficient revenue. Revenue is impacted mainly by the degree of reliability, availability and maintainability. The reliability, availability and maintainability of a plant depend largely on the plant's configuration. Gasification plants can be designed with a large number of different options with respect to redundancy. They may comprise several modules, such as the gasification island, coal milling module, air separation module, the gas treatment or chemical or power production module. Each module may consist of several sub-systems. For the modules, different redundancy options may be chosen, possibly providing spare capacities.

Therefore, it is very important to define an optimum of the expected values for the reliability, availability and maintainability values versus the costs of the plant.

In the art it is known to schedule maintenance plans manually based directly on individual experience. However, the effects on availability and equivalent output cannot be derived directly. Furthermore, no optimal maintenance harmonization across the different plant modules and subsystems may be performed automatically.

Therefore, the need still remains of reliably defining an optimum for the expected values for reliability, availability and maintainability versus the costs of the plant.

### SUMMARY OF THE INVENTION

According to one aspect of the invention, there is provided a method for optimization of maintenance plans for a plant, comprising providing input data comprising at least one of a plurality of indicia regarding a configuration of the plant and a plurality of constraints regarding planned outages of the plant, optimizing the input data, and generating a maintenance plan with maximum equivalent output per a defined observation period regarding the plant.

In a further embodiment, the step of optimizing the input data comprises creating a random sequence of plant modules to walk through. In yet a further embodiment, the step of optimizing said input data further comprises, for each module in the sequence, constructing a set of POSSIBLE OUTAGE DATES (Ω), and choosing a plurality of random sequence offsets of planned outages (ω) in Ω.

In still a further embodiment, the method comprises, for each ω of the sequence, constructing a set of representative starting dates, and choosing a random sequence of the planned outages in ω. In accordance with the present invention the step of optimizing said input data further comprises, for each planned outage in the sequence of choosing random sequence of the planned outages, assigning an outage to the starting date which gives best evaluation results for the plant's output. The present invention also comprises the step of improving the generated maintenance plan via local optimization. The method further comprises, if the generated schedule is better than the schedule already available, saving the generated schedule, adapting a threshold value ξ relative to the best solution encountered to this new best plant output schedule, saving the schedule as a the maintenance plan with maximum equivalent output per observation period, and stopping the computation for the current module if the elapsed time is larger than a predefined time limit. If the generated schedule is not better than the schedule already available, the method further comprises choosing a random sequence for the planned outages in ω. The step of optimizing the input data is repeated if the schedule was improved.

According to another aspect of the invention, there is provided a program product for generating system specifications, comprising a computer usable medium including a computer readable program, wherein the computer readable program when executed on a computer causes the computer to provide input data comprising at least one of a plurality of indicia regarding a configuration of the plant and a plurality of constraints regarding planned outages of the plant, optimize the input data, and generate a maintenance plan with maximum equivalent output per a defined observation period regarding the plant.

In accordance with the present invention, maintenance plans for industrial plants such as gasification plants can be optimized with respect to availability and expected total equivalent output of the plant automatically. Availability and output are calculated and the best maintenance plan is the solution which will be taken. The quantification of the effect of difference maintenance plans is essential for the economic appraisal of a gasification plant. The method of the present invention may be used in the early phases of a project, such as part of a feasibility study or latter, after the plant has been implemented and needs to be maintained. Therefore, the overall expected revenue and the influence of the maintenance plans upon the economical feasibility of the plant is transparent to the plant operator or designer.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is a flow chart diagram illustration of a method for optimization of maintenance plans for a plant, according to an embodiment of the invention;

FIG. 2 is a flow chart diagram illustration of a method for optimization of maintenance plans for a plant, according to another embodiment of the invention;

Table 1 represents the maintenance schedule specification and resulting spread outages for an embodiment of the present invention; and

Table 2 represents the maintenance schedule specification and resulting synchronous outages, in accordance with another aspect of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures and components have not been described in detail so as not to obscure the present invention.

Unless specifically stated otherwise, as apparent from the following discussions, it is appreciated that throughout the specification discussions utilizing terms such as “processing”, “computing”, “calculating”, “determining”, “generating”, “configuring” or the like, refer to the action and/or processes of a computer that manipulates and/or transforms data into other data, said data represented as physical, e.g. such as electronic, quantities. The term “computer” should be expansively construed to cover any kind of electronic device with data processing capabilities, including, by way of non-limiting example, personal computers, servers, handheld computer systems, Pocket PC devices, Cellular communication device and other communication devices with computing capabilities, processors and microcontrollers (e.g. digital signal processor (DSP) possibly in combination with memory and storage units, application specific integrated circuit “ASIC”, etc.) and other electronic computing devices.

The operations in accordance with the teachings herein may be performed by a computer specially constructed for the desired purposes or by a general purpose computer specially configured for the desired purpose or for the desired operations by a computer program stored in a computer readable storage medium.

In addition, embodiments of the present invention are not described with reference to any particular programming language. It will be appreciated that a variety of programming languages may be used to implement the teachings of the inventions as described herein.

Gasification and integrated gasification combined cycle plants have been shown to contribute to environmentally friendly chemical production as well as to an energy portfolio with reduced CO2 emissions. Despite their important contribution to environmentally friendly industrial practices, little experience is possessed today with their realization and operation. It will be appreciated that the present invention may refer as well to a variety of other industrial plants besides the ones specified above, in exemplary fashion.

One important aspect related to the realization and operation of these industrial plants are the high capital expenses incurred with the construction of the plants. In order for the plants to be economically viable, their initial expenses should be offset by sufficient revenue. Revenue is impacted mainly by the degree of reliability, availability and maintainability. The reliability, availability and maintainability of a plant depends largely on the plant's configuration. Gasification plants can be designed with a large number of different options with respect to redundancy. They may comprise several modules, such as the gasification island, coal milling module, air separation module, the gas treatment or chemical or power production module. Each module may consist of several sub-systems. For the modules, different redundancy options may be chosen, possibly providing spare capacities. If spare equipment can compensate output loses during down times of individual subsystems, it is essential to schedule planned maintenance in a way which takes advantage of the proposed module structure. Furthermore, maintenance harmonization across the modules is important to minimize times with reduced output.

Therefore, it is very important to define an optimum of the expected values for the reliability, availability and maintainability values versus the costs of the plant. In this respect, the present invention proposes among others how to optimize maintenance plans across all the modules and system parts of the plant. The present invention proposes a method of deriving maintenance plans for gasification and integrated gasification combined cycle plants and achieving optimized availability and expected total equivalent output for the plant.

In accordance with one of its embodiments, the present invention is directed to a method for the optimization of maintenance plans with respect to availability and expected total equivalent output. In accordance with the present invention, optimization is envisioned to be performed within each individual module, as well as across all modules. Thereby, several constraints are taken into account.

To this end, the method for the optimization of maintenance plans proposed by the present invention is applied to a combinatorial optimization problem, regarding both the plant overall and regarding its individual modules, and as a result the method produces an optimized maintenance plan, with an optimal setting of the starting time for the planned outages.

Therefore, the objective function for the method of the present invention is to minimize the loss of total equivalent output by planned outages for an observation time period. To this end at least the following variable should be optimized, such as the starting times for all planned outages of each sub-module.

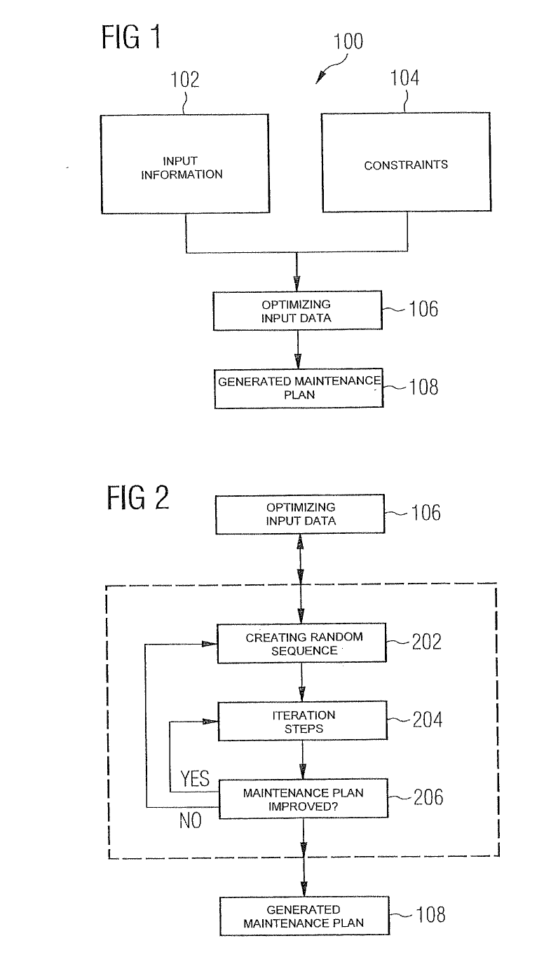

Reference is now made to FIG. 1 which is a flow-chart illustration of a method for optimization of maintenance plans, according to an embodiment of the invention.

The information that constitutes the input for the method for optimization of maintenance plans 100, according to an embodiment of the invention, may be for example the observation time period. Further input data is the configuration of the modules and a specification regarding the planned outages. The modules configuration specifies if sub-modules are redundant or oversized, and which are the dependencies between sub-modules. The configuration may also contain information regarding the equivalent module output corresponding to the number of sub-modules working.

Further, the input information specifies how much maximum operational time is available and what is the minimum amount of time between planned outages, and how much the various outages are planned to take. This type of information is gathered and inputted regarding each sub-module. Further, information regarding plant configuration constitutes as well input information.

Therefore, in FIG. 1, indicated with numeral 102 is presented the input information regarding the configuration plant that may exemplarily comprise information regarding the dependencies, redundancies of the plant modules and sub-modules, information regarding their equivalent output, observation period, modules configuration, or any other information readily apparent to a person skilled in the art that reviews the configuration of an exemplary industrial plant.

The above specified input data affects the optimal schedule of planned outages, since the overall equivalent output differs for simultaneous and spread outage periods of the sub-modules. It has been observed that redundancies of sub-modules will make spread outages advantageous, and dependencies between sub-modules will make simultaneous outages preferable.

A further category of input information, indicated in FIG. 1 with 104, are the plurality of constraints that are inputted regarding the optimization method. One type of constraint is introduced to the specification by minimal and maximal operation time periods between planed outages of the sub-modules. Another type of constraint is introduced by the possibility to specify calendar periods to be free of planned outages. They have to be taken into account when looking for feasible solutions.

Therefore, it is envisioned in accordance with the present invention that constraints regarding the planned outages, indicated in box 104, may be the min/max operational time, the duration outages, the up-times in calendar, constraints regarding the staff, the observation time period and the specification of planed outages.

Should the above be analyzed on the plant overall level, a necessary plant outage of one module reducing the equivalent plant output can be used to hide the output reduction that is caused by the outage of another module. This interaction changes the maintenance plans that would be achieved by optimizing each single module separately.

Therefore, to summarize, the method 100 proposed by the present invention comprises at least the step of providing at step 102 input data comprising at least a plurality of indicia regarding the plant configuration and at step 104 a plurality of constraints regarding the planned outages.

The input data is optimized in an optimization step 106 that takes into consideration the input data and the plurality of constraints, and based on the provided information, generates in step 108 a maintenance plan with maximum equivalent output per previously defined observation period.

As the planned outages cannot easily be scheduled in a way that the overall equivalent output of the plant is maximized, an automatic optimization of the scheduling process is provided by a configuration tool. In connection with the following explanations the milling module is taken as an example module comprised within the exemplary industrial plant. The following details are applicable as well for other modules. In order to simplify the following explanations, it is assumed that the number of plant outages is small.

A Maintenance Schedule Specification and resulting spread outages are illustrated in Table 1.

As it may be observed from the table, three planned outages have been specified in the maintenance schedule specification. For each planned outage, the outage durations are specified, as 9, 21, and 8 days. The variability of the operation time before each outage is specified to be 8 to 12, 6 to 12, and 0 to 12 weeks.

Depending on the specification of the milling system, i.e. how much the equivalent output will be for each number of working mills, it is advantageous, for the maintenance work for the mills to be done in parallel or at different time periods. Table 1 shows a possible result, when the output of one mill is more than ⅓ of the total output. The result will be different when the outage of the first mill reduces the total output by more than ⅓ of the total output. If taking out one mill from operation also reduces the output of the other mills, the results are different. Table 2 shows a possible result, where all outages are occurring simultaneously.

Synchronized outages might also be caused by the necessary planned outages of the silos, which represent another submodule of the milling module. Also, planned outages of another module, such as the gasification island, can lead to synchronous outages. Planned outage scheduling becomes quite complex, when a plant configuration includes several modules with each module having planned maintenance requests as in the appended tables.

The recommended starting dates can be written into the maintenance files via a command button of the configuration tool, “Write Planned Outages to Maintenance Files” on the plant configuration sheet. The input operation has to be done at the same time as the calculations will read the specifications of the planned outages from these external files, that can also be edited manually.

The number of possible combinations for the starting dates grows very quickly. Therefore, promising candidates must be filtered out without loosing a possible solution. The first step constructs look-up tables containing the equivalent plant's outputs for the different combinations of synchronous and asynchronous planned outages. This is an important prerequisite to quickly assess a possible choice of starting dates.

The scheduling for the submodules within one module can be performed as follows:

The first step is to set up the intervals of possible starting dates for each planned outage of the submodules.

The next step is to pace through each day of the observation period and to select all planned outages that are possible during the current day. Via all planned outages that are possible during the current day are built sets (ω) of planned outages. Each set is constructed such that it contains only at most one planned outage per submodule. For any two sets ω none of both is the subset or superset of the other. The set of all ω builds a set of planned outages (Ω).

As handling these sets ω still means to consider the large number of all possible combinations of planned outages, the sets are treated one by one. The number of possible sequences is again growing fast, and it represents the factorial of the number of sets ω.

In the next step, loops are used by the configuration tool, to describe the possible number of combinations for the planned outages.

Loop 1: For each module contained in the plant do;

Loop 2: For each ω in above set Ω do;

Loop 3: For each planned outage k in ω consider all its possible starting dates combined with all possible starting dates for the other planned outages j in ω with j>k.

Here means for the evaluation of the expected equivalent output of the plant have to be considered.

In general the configuration tool cannot run the loops completely. Only a subset Λ of all starting point combinations can be considered. This subset Λ will be growing iteratively with each evaluation of starting points' combinations.

It is important to make the search for the solution fast, and skip uninteresting candidates. On the other hand, the construction of Λ must lead to the whole set of candidates considered by the loops above. Avoiding uninteresting evaluations is accomplished by looking at only candidates representing equivalence classes. The equivalence classes have the property that each member of the equivalence class leads to the same plant's output. This is obvious when planned outages are at different times and shifting them small time intervals does not change the plant's output when there is enough operating time between the planned outages.

For each ω the best scheduling of planned outages is searched in the set A of representatives of starting days. Again this number of possible combinations might still be too high to step through each single one. Therefore, a random selection is made for the set A.

In order to construction the equivalence classes, representatives are created. For example, starting dates are chosen such that all combinations of planned outages are included. The extreme combinations are “all at the same time” and “all at different times”. But also planned outages of any specific submodules are possible to be synchronized, for example the representatives can be chosen accordingly: Let M be the number of planned outages in the set of planned outages. Then M dates might be chosen such that the times between each two are longer than the maximal duration of planned outages. For symmetry reasons the number of combinations M times M can be reduced to M·(M+1)/2 to cover all possible synchronizations of planned outages. Further, starting dates have to be considered if other planned outages for other modules have already been chosen to start or end on days that also the planned outages in ω might be. Here the sequence in which the modules are treated is important, as the synchronization possibility might be apparent only for one and not the other sequence. But this effect is mitigated as the same sequence of modules is used to loop through the modules several times: The loop is repeated as long as an improvement for the plant's output can be achieved.

Local optimization steps are performed for candidates reaching a threshold value ξ relative to the best solution encountered, e.g. reaching 90% of the plant's output that is achieved for the currently best schedule. These local steps check if small time shifts of starting dates can further improve the plant's output.

To generate a stopping criterion the scheduling task is solved without the restrictions for the time between planned outages, as shown in table 1. For this unrestricted task a maximal value for the plant's output is computed and used as an upper limit for the restricted task. The computation can be stopped if the schedule for the restricted task achieves this value.

The implementation goes through the loops in the following way:

Solve the unrestricted scheduling task according to method described below.

Use this computed maximal plant's output as a limit for the restricted task. When this limit is reached during the iterative process below, the method can be stopped.

Therefore, to summarize, the exemplary optimization method step 106 described above comprises at least:

Creating random sequence of plant modules to walk through;

For each module in the sequence:

Constructing set of planned outages (Ω);

Choosing random sequence of m in possible outage dates (Ω) set;

For each ω of the sequence:

Constructing set of representative starting dates;

Choosing random sequence of the planned outages in ω;

For each planned outage in the sequence of step of choosing random sequence of the planned outages in ω:

Assign outage to the starting date which gives best evaluation result for the plant's output;

If plant's output for current schedule is better than threshold value ξ trying to improve the schedule further with local optimization steps.

If current schedule is better than current best schedule the following steps are proposed to be executed: the schedule is saved as best and the threshold value in adapted to this new best plant output value. If a solution schedule has been found, such as the plant's output reaches the computed limit of the unrestricted task, this schedule should be saved as a solution and the computation of the current module is stopped. The computation on the current module is also stopped if the elapsed time is larger than a predefined limit. If not, the algorithm continues with choosing a random sequence of the planned outages in ω and continues as described above, with the steps subsequent to this choice.

If the current schedule is not better the current best schedule, and if the elapsed time is larger than a predefined limit, the computation for the current module is stopped. Otherwise, the algorithm continues at the step of choosing a random sequence of ω in the set of planned outages (Ω).

Saving the schedule as best and adapting the threshold value ξ to this new best plant's output is also comprised in the algorithm.

If a solution schedule has been found, i.e. the plant's output reaches the computed limit of the unrestricted task, saving this schedule as solution and stopping computation for the current module is further comprised by the algorithm.

Stopping computation for the current module if the elapsed time is larger than a predefined limit is further yet comprised by the algorithm.

Continuing with the step of choosing random sequence of the planned outages in ω is also a step in the algorithm.

If the elapsed time is larger than a predefined limit, the computation is stopped for the current module. Otherwise, the computation continues with the step of choosing a random sequence of ω in the set of planned outages (Ω).

The preceding sequence of steps is repeated, if the schedule was improved. Otherwise, the iteration is started from the beginning.

Reference is now made to FIG. 2 which is a flow chart diagram illustration of a method for optimization of maintenance plans for a plant, according to another embodiment of the invention. According to some embodiments, the method for optimization of maintenance plans for a plant comprises, as illustrated in the figure and as discussed in detail above, the steps of optimizing input data 106, that takes into consideration the input data and the plurality of constraints, and based on the provided information, generating in step 108 a maintenance plan with maximum equivalent output per previously defined observation period.

The optimization step 106 comprises at least the step of creating a random sequence of plant modules to walk through 202, and for each module in the sequence, the step 204 that comprises iteration steps regarding the input data and the inputted constraints. If the maintenance plan schedule was improved in step 204, the method advances to repeat the iterations steps 204 and if the maintenance plan schedule was not improved in step 204, the method returns to the step of creating a random sequence of plant modules to walk through, therefore generating in step 108 a maintenance plan with maximum equivalent output per previously defined observation period.

The following observations are derived form the application of the method summarized above:
When a loop is done the first time, there is no stopping criterion, as the other planned outages are yet not considered. Therefore all loops must be gone through at least once before a stopping criterion can be checked.
When random sequences are reconstructed or chosen in steps 1 and 2b, the performed assignments of planned outages to specific dates become obsolete.
Setting threshold value ξ to zero means that local optimization steps are always performed.
Additionally or alternatively to the monitoring of the elapsed time a maximal number of iterations can be used to leave a current loop.
Random sequences are chosen to accelerate the algorithm. They ensure that the search visits different parts of the space to be searched. Otherwise one, possibly uninteresting part is searched intensively, before the next part is searched. The random way will see interesting parts earlier and the local optimization shall find good solution in these parts.

The embodiments of the invention, and any means, modules or blocks discussed, can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the embodiments of the invention can take the form of a computer program product accessible from a computer-usable or computer-readable medium providing program code for use by or in connection with a computer, processing device, or any instruction execution system. For the purposes of this description, a computer-usable or computer readable medium can be any apparatus that can contain, store, communicate, or transport the program for use by or in connection with the instruction execution system, apparatus, or device.

The medium can be electronic, magnetic, optical, or a semiconductor system (or apparatus or device). Examples of a computer-readable medium include, but are not limited to, a semiconductor or solid state memory, magnetic tape, a removable computer diskette, a random access memory (RAM), a read-only memory (ROM), a rigid magnetic disk, an optical disk, etc. Current examples of optical disks include compact disk-read only memory (CD-ROM), compact disk-read/write (CD-R/W) and digital versatile disk (DVD).

I/O devices (including but not limited to keyboards, displays, pointing devices, etc.) can be connected to the system either directly or through intervening controllers. Network adapters may also be connected to the system to enable the data processing system to become connected to other data processing systems or remote printers or storage devices through intervening private or public networks. Modems, cable modem and Ethernet cards are just a few of the currently available types of network adapters.

The computer program product of the present invention may be a computer program product for generating system specifications, comprising a computer usable medium including a computer readable program, wherein the computer readable program when executed on a computer causes the computer to provide input data comprising at least one of a plurality of indicia regarding a configuration of the plant and a plurality of constraints regarding planned outages of the plant, optimize said input data, and generate a maintenance plan with maximum equivalent output per a defined observation period regarding the plant.

In the description above, numerous specific details are set forth. However, it is understood that embodiments of the invention may be practiced without these specific details. For example, well-known equivalent components and elements may be substituted in place of those described herein, and similarly, well-known equivalent techniques may be substituted in place of the particular techniques disclosed. In other instances, well-known structures and techniques have not been shown in detail to avoid obscuring the understanding of this description.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other modifications may occur to those ordinarily skilled in the art.

In accordance with the present invention, maintenance plans for industrial plants such as gasification plants can be optimized with respect to availability and expected total equivalent output of the plant automatically. Availability and output are calculated and the best maintenance plan is the solution which will be taken. The quantification of the effect of difference maintenance plans is essential for the economic appraisal of a gasification plant. The method of the present invention may be used in the early phases of a project, such as part of a feasibility study or latter, after the plant has been implemented and needs to be maintained. Therefore, the overall expected revenue and the influence of the maintenance plans upon the economical feasibility of the plant is transparent to the plant operator or designer.

It would be appreciated that a further aspect of the present invention may relate to implementing the method of the invention an apparatus. While in various places throughout the description of some embodiments of the present invention, a process of optimization of maintenance plans for a plant, is described in the context of a particular apparatus on which the process may be implemented, further embodiments of the invention are not limited in this respect. According to such embodiments, the process of optimization of maintenance plans for a plant may be implemented on any suitable computerized device, and in particular on a computerized device which includes or that is connectable to various user input and output modules or devices. In still further embodiments the process of optimization of maintenance plans for a plant may be implemented on a computerized device that is connected to various enterprise data resources and enterprise data processing entities.

In addition, the invention contemplates a computer program being readable by a computer for executing the method of the invention. The invention further contemplates a machine-readable memory tangibly embodying a program of instructions executable by the machine for executing the method of the invention.

Furthermore, it would be appreciated that yet a further aspect of the present invention may relate to a system for optimization of maintenance plans for a plant. The optimization of maintenance plans system, in which the apparatus is part of, may include additional data repositories and data processing entities or platforms. Throughout the description of some embodiments of the present invention, reference was made to various data repositories and data processing entities which are operatively connected to a device implementing the apparatus and which may thus jointly constitute a maintenance assistance and control system in accordance with some embodiments of the invention.

While certain features of the invention have been illustrated and described herein, many modifications, substitutions, changes, and equivalents will occur to those skilled in the art. It is therefore to be understood that the appended claims are intended to cover all such modifications and changes as fall within the true scope of the invention.

TABLE 1
Maintenance Schedule Specification and resulting spread outages
Planned Outages of Mills
Number of Outages: 3

| Operation | | Recommended Starts of | | | |
|---|---|---|---|---|---|
| Time before | Outage | Planned Outages [Year\|Month\|Day] | | | |
| Outage | Max | Duration | | | |
| Min [Weeks] | [Weeks] | [d] | M1 | M2 | M3 |
| 8 weeks | 12 weeks | 9 days | 01\|03\|25 | 01\|03\|15 | 01\|03\|05 |
| 6 weeks | 12 weeks | 21 days | 01\|06\|25 | 01\|06\|03 | 01\|05\|12 |
| 0 weeks | 12 weeks | 8 days | 01\|10\|07 | 01\|09\|15 | 01\|08\|24 |

TABLE 2
Maintenance Schedule Specification and resulting synchronous
outages
Planned Outages of Mills
Number of Outages: 3

| Operation | | Recommended Starts of | | | |
|---|---|---|---|---|---|
| Time before | Outage | Planned Outages [Year\|Month\|Day] | | | |
| Outage | Max | Duration | | | |
| Min [Weeks] | [Weeks] | [d] | M1 | M2 | M3 |
| 8 weeks | 12 weeks | 9 days | 01\|03\|26 | 01\|03\|26 | 01\|03\|26 |
| 6 weeks | 12 weeks | 21 days | 01\|06\|27 | 01\|06\|27 | 01\|06\|27 |
| 0 weeks | 12 weeks | 8 days | 01\|10\|10 | 01\|10\|10 | 01\|10\|10 |

1. A method for optimization of maintenance plans for a plant, comprising:
providing input data comprising at least one of a plurality of indicia regarding a configuration of the plant
providing a plurality of constraints regarding planned outages of the plant;
optimizing said input data; and
generating a maintenance plan using a computer processor with maximum equivalent power output and availability of the plant per a defined observation period,
wherein the configuration of the plant includes a plurality of plant modules.

2. The method for optimization of maintenance plans for a plant of claim 1, wherein the step of optimizing said input data comprises creating a random sequence of plant modules to walk through.

3. The method for optimization of maintenance plans for a plant of claim 2, wherein the step of optimizing said input data further comprises, for each module in the sequence, constructing a set of planned outages (Ω), and choosing a plurality of random sequence offsets of planned outages (ω) in Ω.

4. The method for optimization of maintenance plans for a plant of claim 2, wherein the step of optimizing said input data further comprises, for each ω of the sequence, constructing a set of representative starting dates, and choosing a random sequence of the planned outages in ω.

5. The method for optimization of maintenance plans for a plant of claim 2, wherein the step of optimizing said input data further comprises, for each planned outage in the sequence of choosing random sequence of the planned outages, assigning an outage to the starting date which gives best evaluation results for the plant's output.

6. The method for optimization of maintenance plans for a plant of claim 1, further comprising improving the generated maintenance plan via local optimization.

7. The method for optimization of maintenance plans for a plant of claim 6, wherein when the generated schedule is better than the schedule already available, the method further comprises,
saving the generated schedule,
adapting a threshold value relative to the best solution encountered to this new best plant output schedule,
saving the schedule as a maintenance plan with maximum equivalent output per observation period, and
stopping the computation for the current module if the elapsed time is larger than a predefined time limit.

8. The method for optimization of maintenance plans for a plant of claim 6, wherein if the generated schedule is not better than the schedule already available, the method further comprises choosing a plurality of random sequence offsets off planned outages ω in Ω.

9. The method for optimization of maintenance plans for a plant of claim 2, wherein the step of optimizing said input data is repeated if the schedule was improved.

10. A computer program product for generating system specifications, comprising:
a durable computer usable medium including a computer readable program,
wherein the computer readable program when executed on a computer causes the computer to:
provide input data comprising at least one of a plurality of indicia regarding a configuration of the plant and a plurality of constraints regarding planned outages of the plant;
optimize said input data, and
generate a maintenance plan with maximum equivalent power output and availability of the plant per a defined observation period regarding the plant.

11. The method as claimed in claim 1, wherein the input data comprises observation time period, configuration of the plurality of plant modules, minimum amount of time between planned outages, and time for planned outage.

12. The method as claimed in claim 1, wherein the constraint data comprises minimum and maximum operational time between outages, the duration of the outages, date constraints, and staff constraints.
